(19) United States
(12) Patent Application Publication
(10) Pub. No.: US 2026/0369158 A1
(43) Pub. Date: Nov. 19, 2026

(54) INTEGRATED WIRELESS LOCKSET AND PRESENCE DETECTION SYSTEM FOR PANIC BAR DOORS

(71) Applicant: EYES OPEN Corp., Manassas, VA (US)

(72) Inventor: Anatoli Stobbe, Barsinghausen (DE)

(21) Appl. No.: 19/682,339

(22) Filed: May 19, 2026

Related U.S. Application Data
(60) Provisional application No. 63/808,595, filed on May 19, 2025.

(51) Int. Cl. G08B 29/18; G07C 9/20; G08B 13/08; G08B 13/19

(52) U.S. Cl. CPC G08B 29/185; G07C 9/20; G08B 13/08; G08B 13/19

(57) ABSTRACT

A wireless access control system for doors equipped with mechanical panic bars enables secure ingress and intelligent egress monitoring using a combination of external credential readers and internal presence detection. The system includes a wireless lockset with a clutch mechanism activated by a validated credential from an external reader. On the inside, a motion-based presence detector is positioned near the panic bar. When a user approaches the door from the secured side and activates the panic bar, the presence detector overrides the door sensor input to indicate authorized egress, preventing false intrusion alerts. The system communicates wirelessly and supports multiple operational modes, including centralized online control, local autonomous logic, and credential-based distributed logic. The system integrates with standard mortise and tubular locks, allowing cost-effective retrofitting to existing emergency exit doors. The access logic dynamically adapts to door events, improving both security response and occupant convenience.

### RELATED APPLICATIONS

This application claims the benefit of U.S. Provisional Patent Application No. 63/808,595 filed on May 19, 2025, the entire contents of which are incorporated herein by reference.

### FIELD OF THE INVENTION

The present invention relates to electronic access control systems for secure facilities, and more particularly to an intelligent wireless access control system with panic bar compatibility. The system is designed for retrofit installation in educational, governmental, and commercial buildings and provides intelligent coordination between external credential validation and internal presence-based override logic. It integrates both centralized and decentralized control methods, enhancing security while preserving functional egress.

### BACKGROUND OF THE INVENTION

Access control systems for doors equipped with panic bars have traditionally struggled to distinguish between authorized and unauthorized openings initiated from the inside. This often results in false alarms and unnecessary lockdowns, especially during legitimate egress in emergency situations. Existing systems typically require full hardware replacement or complex wiring, making retrofitting costly and impractical.

There is a need for a retrofit-capable access control system that works with existing panic bars and provides intelligent detection of user intent, thereby improving both security and usability.

### SUMMARY OF THE INVENTION

The present invention provides a secure wireless access control system for doors equipped with mechanical panic bars. The system includes: an external wireless credential reader capable of engaging a clutch mechanism to unlock the door from the outside; a panic bar on the inside to permit emergency egress; a door sensor that detects the state of the door (open or closed); and an internal presence detector that monitors the area near the panic bar.

When a user approaches the door from the inside and enters the detection range of the internal presence sensor, the system temporarily overrides the input from the door state sensor. This override signals that the door is being used for normal egress via the panic bar rather than forced entry, thereby preventing false breach alarms.

The system is compatible with standard mortise locks and tubular latches, enabling retrofit installations.

The system operates wirelessly and supports multiple operational modes, including real-time communication with a central controller, decentralized local data processing, and credential-based access logic stored on the transponder cards themselves. These flexible modes of operation allow the system to function reliably even in environments with intermittent connectivity or strict security requirements.

### BRIEF DESCRIPTION OF THE DRAWINGS

FIG. 1 is a side view of a door equipped with a wireless lockset, a panic bar, an internal presence detector, and a door sensor according to the present invention.

FIG. 2 is an elevation view showing the wireless lockset and credential reader on the outside of the door in FIG. 1.

FIG. 3 is an elevation view showing the panic bar and internal presence detector on the inside of the door in FIG. 1.

FIG. 4 is an exploded perspective view of the wireless lockset, outside credential reader, panic bar, internal presence detector, and other components of the access control system of the present invention.

FIG. 5 is a perspective view showing the access control system with the internal presence detector on the inside of the door above the panic bar.

FIG. 6 is an exploded perspective view of the access control system with internal presence detector shown in FIG. 5.

FIG. 7 is an exploded perspective view of the wireless lockset with the outside credential reader on the outside of the door for activating a clutch in the door mechanism to open the door.

FIG. 7A is a perspective view of the read head of the outside credential reader used with the wireless lockset.

FIG. 8 is an elevation view of the door clutch mechanism engaged by the outside credential reader.

FIG. 9 is an exploded perspective view of the door clutch mechanism shown in FIG. 8.

FIG. 10 is a schematic block diagram showing the system communication between the wireless lockset, central controller and transponders.

FIG. 11 is a flowchart showing the decision logic of the access control system for access authorization, door opening detection, and override functions.

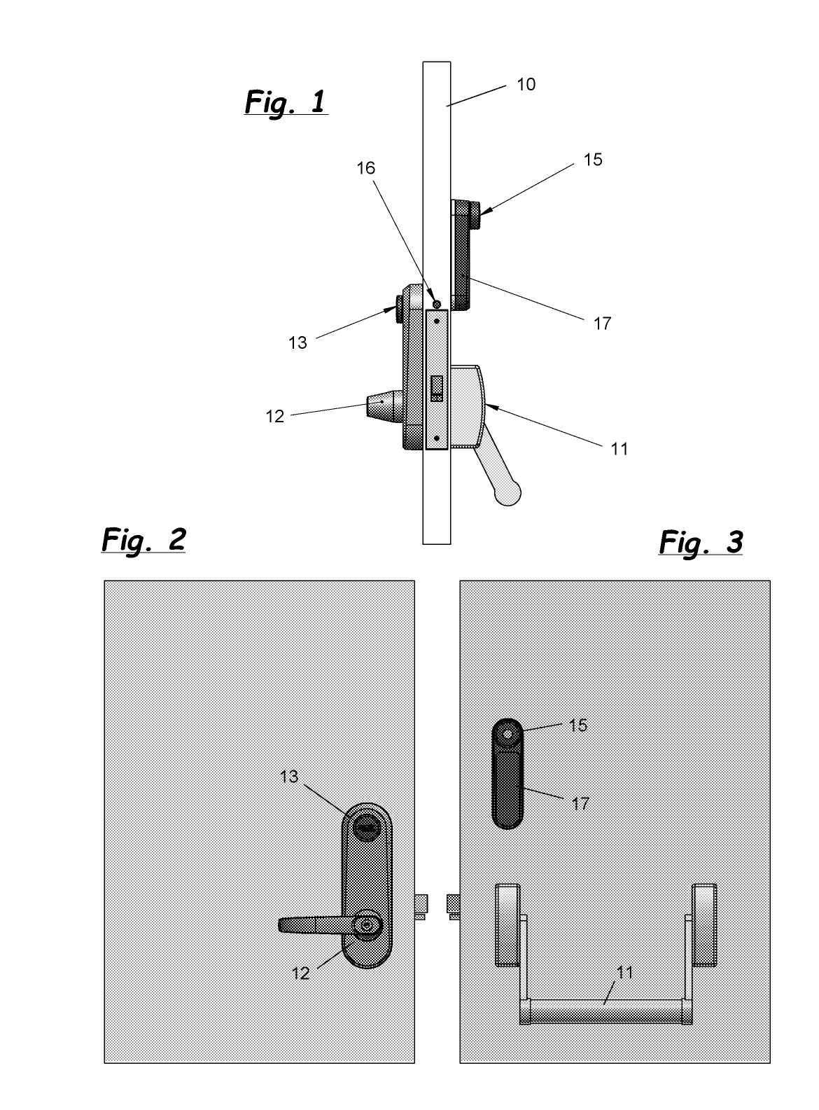

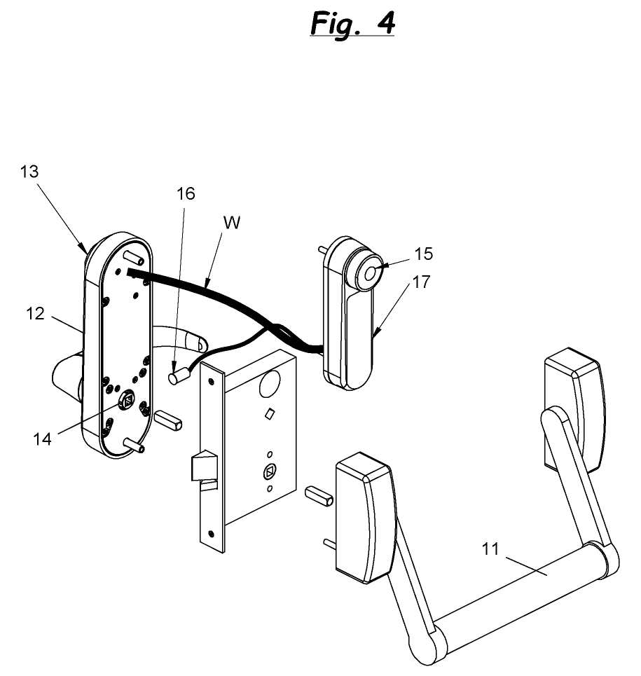

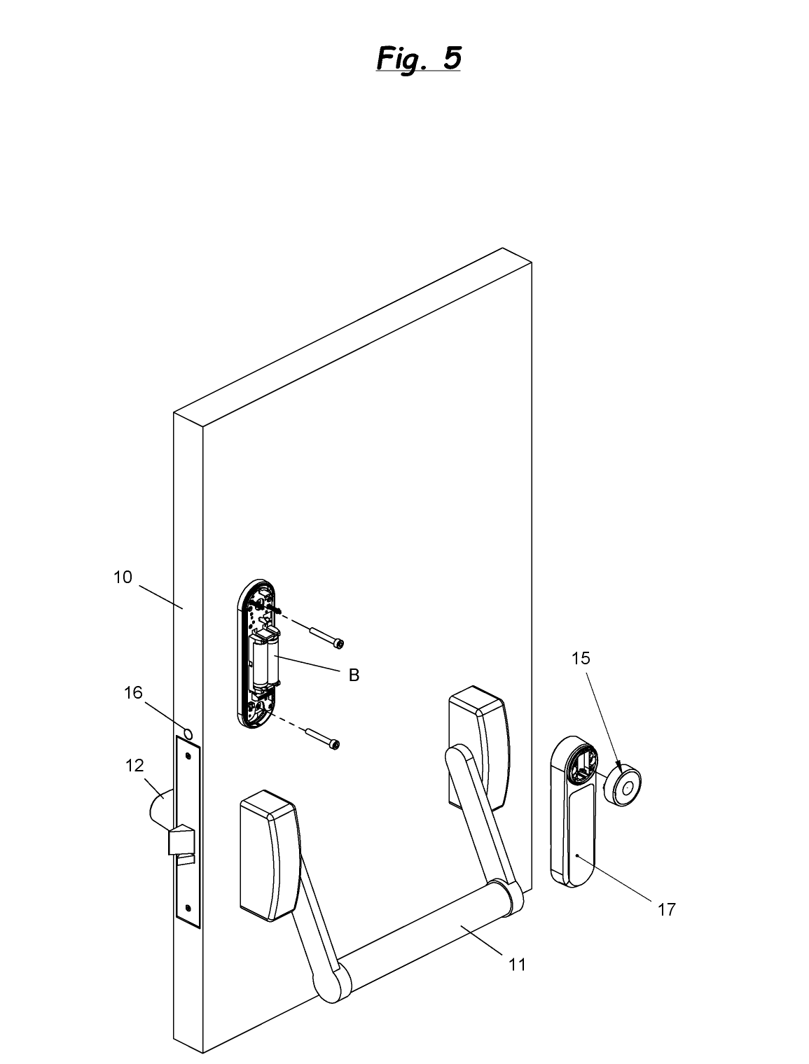

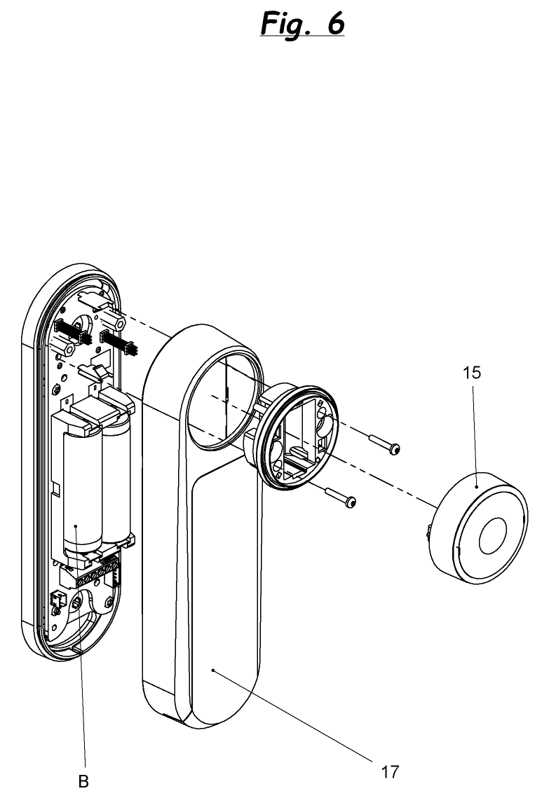

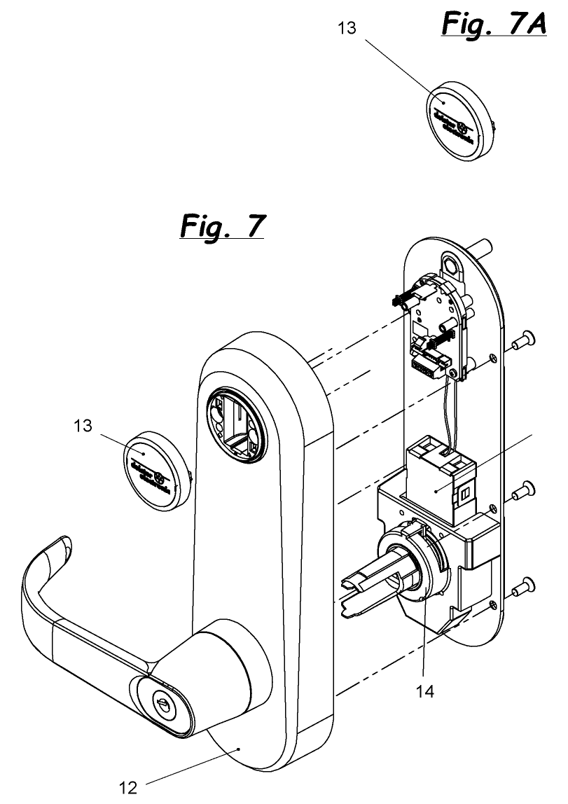

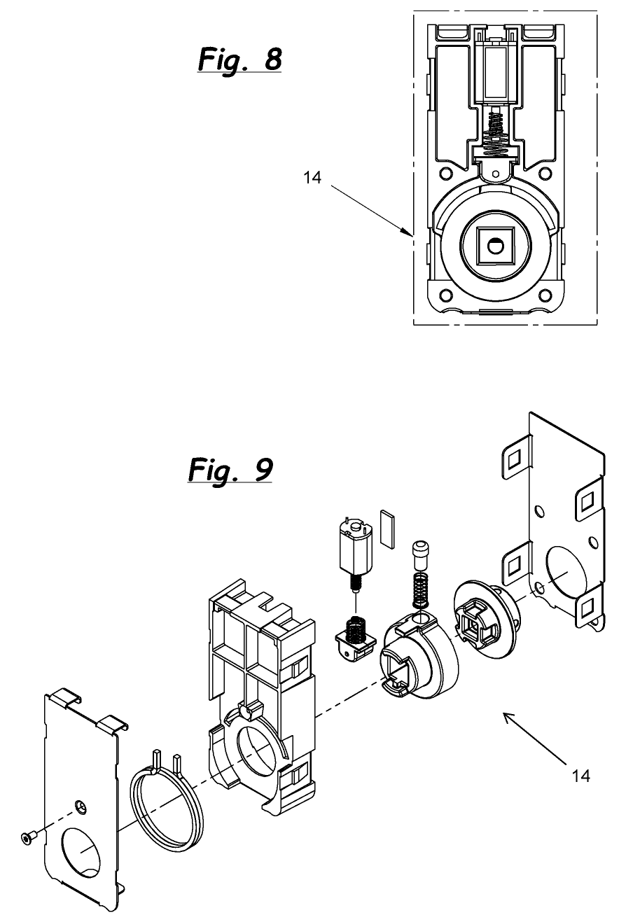

### DETAILED DESCRIPTION OF THE INVENTION

The invention comprises a wireless access control system configured for doors 10 with panic bars 11. The access control system is built around a wireless lockset 12, which integrates with an existing panic bar mechanism 11 and includes the following key components:

### Outside Reader Head with Wireless Gateway

Positioned on the unsecured side of the door 10, the reader 13 supports multiple credential formats (e.g., MIFARE®, HITAG, BLE). The reader 13 validates user credentials and, upon successful authentication, wirelessly engages a clutch mechanism 14 to permit unlocking from the outside.

### Internal Presence Detector

The internal presence detector 15 is mounted near the panic bar on the secured side and uses infrared or similar motion detection technology to identify the approach of a person intending to exit. When activated, the internal presence sensor 15 overrides the door sensor 16 to prevent triggering of a forced-entry alarm.

The internal presence detector 15 is strategically located above or adjacent to the panic bar 11 to monitor movement within a defined detection zone. The detection zone is tuned to recognize the physical approach of a user intending to exit, rather than incidental motion elsewhere in the room. Upon detecting presence of a user approaching on the secured side of the door 10, the system temporarily overrides the door presence sensor logic and flags the egress as "expected," effectively disabling any breach alarm that would otherwise be triggered by a door opening without external credential input. The internal presence detector 15 communicates with the onboard or central logic controller to tag the door event appropriately in system logs and ensure proper system reset after the door 10 recloses.

The internal presence detector 15 may further include environmental calibration features, such as ambient light or thermal compensation, to reduce false positives and improve reliability in dynamic settings. Battery status and health of the sensor unit are reported periodically to the controller C for maintenance tracking.

The internal presence detector 15 is contained within a subunit 17 mounted on the inside surface of the door 10. The batteries B contained within the subunit 17 are connected by wires W to and provide power for the internal presence detector 15, the outside lockset 12, and the door presence sensor 16. A logic system within the subunit 17 or the central controller C includes intelligence to prevent false alarms based on the internal presence detector 15 and the door presence sensor 16.

### Door Presence Sensor

The door presence sensor 16 detects the physical state of the door (open or closed). When triggered, the system checks if an outside access command was received or if the internal presence detector 15 was activated. If neither, the system may initiate a security response.

### Compatibility with Existing Hardware

The wireless lockset 12 supports mounting on standard left- or right-handed doors, and can integrate with tubular latches or mortise locks. This retrofit compatibility makes it suitable for upgrading legacy doors without full hardware replacement.

### Operating Modes and Connectivity

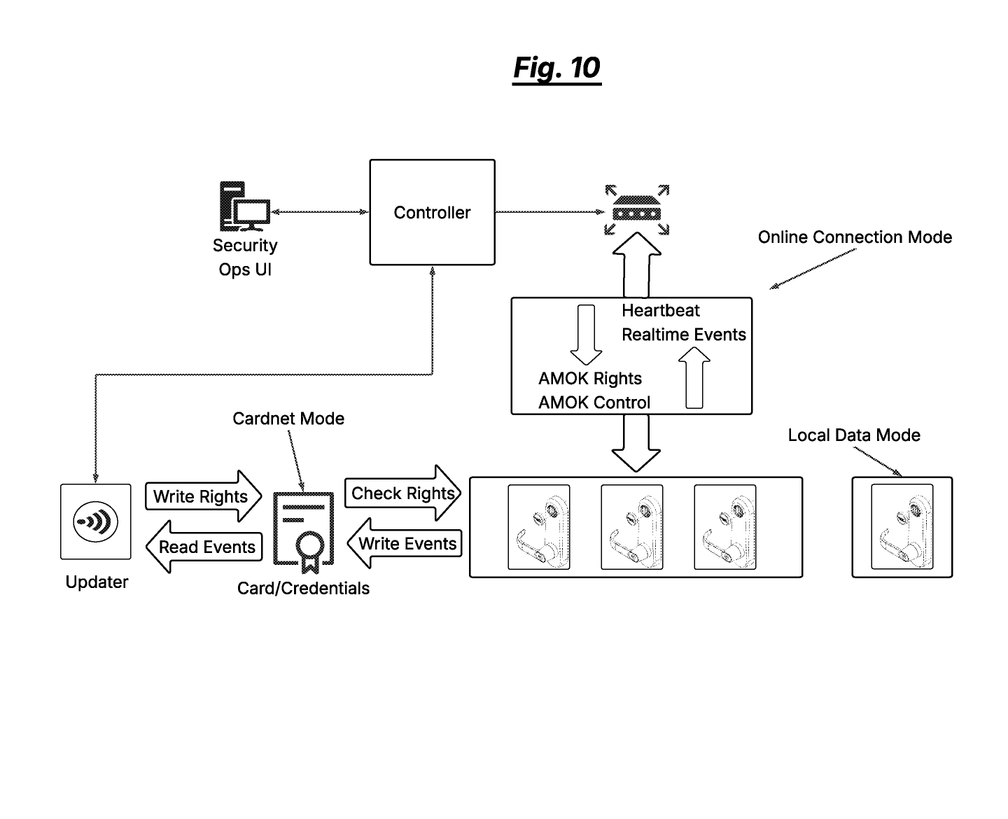

As illustrated in FIG. 10, the system supports three combinable operating modes that offer scalable levels of network dependency and autonomy:
1. Online Connection mode enables real-time communication between the access control components and a central controller. Credential validation, access logging, and override logic are managed centrally, providing a high degree of administrative control.
2. Local Data mode supports offline functionality with local storage of access permissions and logs. This allows the lockset and sensors to function independently of a live network connection, ensuring continued security even during outages.
3. Card Net mode uses smart credential cards embedded with access rules and schedules. The lockset reads and enforces access control policies directly from the card, allowing for distributed logic without real-time network communication.

The three operating modes may be used independently or in combination, offering flexible solutions for various building architectures and IT security policies.

### Control Logic (via Central Controller or Onboard System)

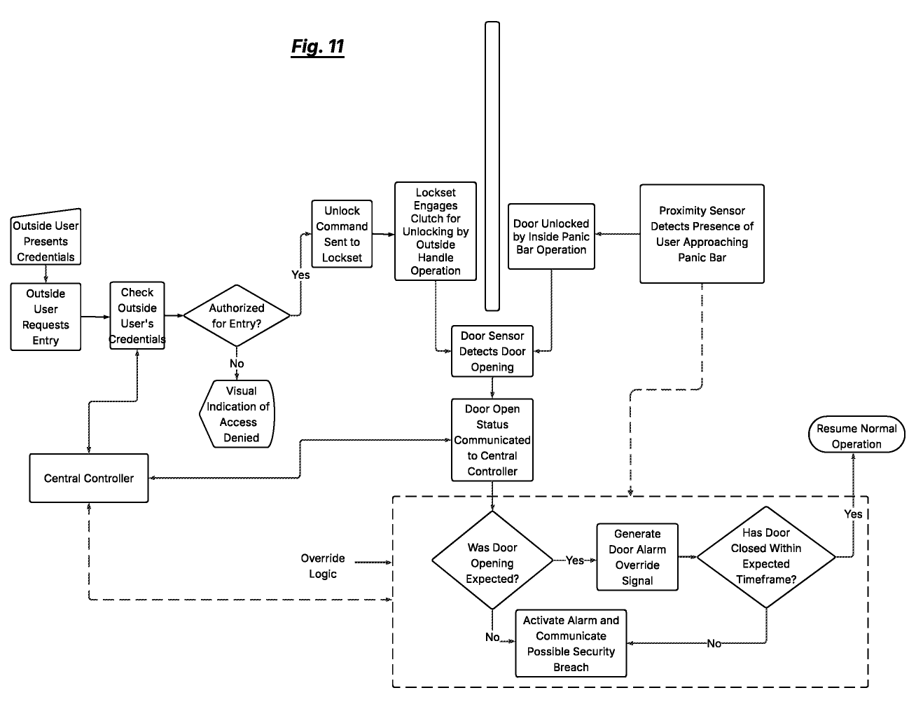

FIG. 11 illustrates an exemplary process flow for controlling access to a secured enclosure, room, cabinet, compartment, safe, lockbox, or other protected area using a credential-based lockset 12, a door-position sensor 16, a proximity sensor 15, and a central controller C. The process may be implemented by one or more processors executing instructions stored in memory, by dedicated control circuitry, or by a combination thereof. Although the illustrated embodiment is described in connection with a door and lockset, the same control logic may be applied to any movable barrier or closure member for which access authorization and post-access security monitoring are desired.

The process begins when an outside user presents credentials to an outside credential reader. The credential reader may include, for example, a keypad, card reader, biometric reader, wireless receiver, mobile-device interface, RFID reader, NFC reader, or other authentication device. In response to receipt of the credentials, the system checks or validates the credentials against locally stored authorization data, remotely stored authorization data, a networked access-control database, or other access-control logic.

The system then determines whether the user is authorized for entry. If the credentials are not authorized, the system generates an indication that access has been denied. The indication may be visual, audible, electronic, logged, transmitted to a remote monitoring system, or any combination thereof. In this denied-access state, the lockset remains locked and normal secured operation continues unless overridden by other system logic.

If the credentials are authorized, the system generates an unlock command to the lockset. The lockset then causes the associated latch, bolt, strike, or other locking mechanism to move from a locked condition to an unlocked condition. Once unlocked, the user may operate the handle or other manual actuator to open the door. The flowchart indicates that the user opens the door by turning or otherwise actuating the handle.

A lockset-mounted sensor may be provided to detect movement or operation of the handle. In one embodiment, this sensor may detect rotation of the handle, displacement of a lever, actuation of a latch mechanism, depression of a push bar, or another mechanical movement associated with door opening. Detection of handle operation may be communicated to the control system as an indication that the user has attempted to enter after authorization.

A door sensor detects opening of the door. The door sensor may include a magnetic reed switch, contact sensor, Hall-effect sensor, optical sensor, accelerometer, hinge-position sensor, latch-position sensor, or any other sensor capable of determining whether the door has moved from a closed position toward an open position. When the door sensor detects that the door is open, a door-open signal is communicated to the central controller.

The central controller receives the door-open signal and initiates monitoring logic for determining whether the door remains open beyond an expected or permitted condition. In the illustrated embodiment, the central controller may also receive information from a proximity sensor. The proximity sensor detects the presence of a user within a defined area near the door opening. The defined area may correspond to an interior approach zone, a region near the handle, a region immediately inside the door, or another monitored space adjacent the door.

The proximity sensor provides a user-presence signal to the control system. In one embodiment, the proximity sensor may include a passive infrared sensor, ultrasonic sensor, radar sensor, lidar sensor, camera-based sensor, capacitive sensor, pressure sensor, wireless device detector, or other presence-detection device. The user-presence signal may be used to distinguish between a door that is open because an authorized user is actively passing through the doorway and a door that has been left open or propped open after access.

The central controller communicates door-open information, user-presence information, authorization information, lockset status, and/or other monitored conditions to door-open logic. The door-open logic evaluates whether the open-door condition is expected. For example, the open-door condition may be expected when the door has recently been unlocked in response to authorized credentials, when the user is detected near the door opening, or when the door is within an allowed open interval. Conversely, the open-door condition may be unexpected when the door is open without corresponding authorization, when the door remains open after the user has moved away, when the door is forced open, or when a time threshold has been exceeded.

If the door-open logic determines that the door-open condition is expected, the system generates a door or alarm override signal. The override signal prevents activation of an alarm, notification, or positive-security breach condition during a permitted access event. In this manner, authorized entry may occur without triggering an alarm merely because the door has temporarily opened.

The override signal is provided to override logic. The override logic may be implemented within the central controller, within a separate alarm controller, within a cloud-based access-control system, or within distributed circuitry. The override logic determines whether alarm generation should be suppressed, delayed, modified, or otherwise controlled based on the expected door-open condition. In one embodiment, the override logic remains active while the user is detected in the door-opening area and/or while a predetermined authorized-entry timer has not expired.

The process further determines whether the door has closed within an expected time interval. This determination may be based on a signal from the door sensor indicating return of the door to a closed position. If the door closes within the expected interval, the system resumes normal operation. Normal operation may include relocking the lockset, clearing any temporary access state, resetting timers, resetting the override condition, logging successful entry, and continuing to monitor the door, lockset, proximity sensor, and credential reader for subsequent events.

If the door does not close within the expected interval, the system activates an alarm and generates a positive-security breach condition. The alarm may include an audible alarm, visual alarm, electronic notification, message to a building-management system, message to a remote security service, entry in an audit log, local annunciation, mobile-device notification, or any combination thereof. The positive-security breach condition may indicate that the door has remained open too long, has been held open, has been propped open, or otherwise presents a security risk despite the initial authorized entry.

The system may also determine whether a door-open condition was expected before generating an alarm. If the door-open condition was not expected, the system may proceed directly to alarm activation and positive-security breach logic rather than generating the door or alarm override signal. Such an unexpected condition may occur, for example, when the door sensor indicates that the door is open without a corresponding authorized unlock command, without detected handle operation, without detected user presence, or outside of an authorized access window.

The dashed-line region of FIG. 11 represents override logic associated with authorized or expected door-opening events. This logic allows the system to suppress or defer alarm generation while the door is open under permitted conditions, but to generate an alarm when the permitted condition ends or when the door remains open longer than allowed. Thus, the illustrated process provides both convenience for authorized users and enhanced security against forced entry, door propping, or failure to resecure the door.

In some embodiments, the central controller may maintain one or more timers. A first timer may begin when the unlock command is issued. A second timer may begin when the door sensor first detects that the door is open. A third timer may be associated with detection of a user by the proximity sensor. The controller may compare elapsed time values to respective thresholds to determine whether the door-open condition remains expected. The thresholds may be fixed, user-configurable, schedule-dependent, credential-dependent, location-dependent, or dynamically adjusted based on prior access events.

In further embodiments, the central controller may combine multiple sensor inputs to reduce false alarms. For example, the controller may require both a valid credential event and door-sensor activation before treating the open-door condition as expected. Alternatively, the controller may require a valid credential event, handle operation, and proximity-sensor confirmation. In another example, the controller may treat an open-door signal without preceding handle operation as a forced-entry condition. In yet another example, the controller may treat an open-door signal followed by absence of user presence and failure to close within a threshold period as a propped-door condition.

The alarm override signal may be temporary and may terminate automatically when the door sensor detects closure of the door, when the proximity sensor no longer detects a user, when an authorization timer expires, when a door-open timer expires, or when another system event occurs. Upon termination of the override signal, continued detection of an open door may cause activation of the alarm and generation of the positive-security breach condition.

The illustrated method therefore provides a controlled access sequence in which authorization, unlocking, handle operation, door-position sensing, user-presence sensing, expected-open-door determination, alarm override, and breach detection are coordinated. By distinguishing expected door-opening events from unexpected or prolonged door-opening events, the system can avoid unnecessary alarms during normal authorized entry while still identifying and responding to potentially insecure door conditions.

While the invention has been described in connection with specific embodiments thereof, it is to be understood that this is by way of illustration and not of limitation, and the scope of the appended claims should be construed as broadly as the prior art will permit.

What is claimed is:

1. A wireless access control system comprising:
an external credential reader;
a clutch mechanism operable by said credential reader;
a mechanical panic bar installed on an inside of a door;
a door sensor configured to detect door open status; and
an internal presence detector configured to override the door sensor input when detecting a user approaching the panic bar.

2. The system of claim 1, wherein said internal presence detector disables security breach alerts upon detecting normal egress initiated via the panic bar.

3. The system of claim 1, wherein said external credential reader is configured to communicate wirelessly with a central controller.

4. The system of claim 1, wherein said door sensor and internal presence detector operate in coordination to determine whether a door opening event was expected or requires alarm activation.

5. The system of claim 1, wherein said internal presence detector comprises an infrared motion sensor configured to detect motion within a predefined field near the panic bar.

6. An access control system for a door with a mechanical panic bar, comprising:
(a) an internal presence detector mounted adjacent the panic bar, configured to detect the presence of a person approaching the panic bar from the secured side of the door;
(b) a door sensor configured to detect when the door is opened;
(c) control logic configured to override input from the door sensor upon activation of the internal presence detector, such that the system classifies the door opening event as authorized egress; and
(d) a central controller or onboard processor configured to record the event and resume monitoring after the door recloses.

7. A method of distinguishing authorized egress from unauthorized entry in an s access control system, comprising the steps of:
(a) detecting motion within a predefined zone near a panic bar using an internal presence detector;
(b) receiving input from a door sensor indicating that a door has been opened;
(c) comparing the timing of the presence detection and the door opening to determine whether the opening corresponds to normal egress;
(d) overriding a security alert if presence detection occurred prior to door opening; and
(e) logging the event as authorized egress and resetting system status after the door is closed.

8. A method of controlling security for a door, the method comprising:
receiving credential information from a credential reader associated with the door;
determining whether the credential information is authorized;
in response to determining that the credential information is authorized, causing a lockset associated with the door to transition from a locked state to an unlocked state;
receiving a door-open signal from a door sensor indicating that the door has moved from a closed position to an open position;
receiving a user-presence signal from a proximity sensor indicating whether a user is present within a monitored area associated with the door;
determining whether the door-open signal corresponds to an expected door-opening event;
in response to determining that the door-open signal corresponds to the expected door-opening event, generating an alarm override signal that suppresses activation of an alarm while the door is open during the expected door-opening event;
determining whether the door returns to the closed position within an expected time interval; and
in response to determining that the door does not return to the closed position within the expected time interval, activating the alarm and generating a security-breach indication.
